(19) United States
(12) Patent Application Publication
(10) Pub. No.: US 2005/0256862 A1
(43) Pub. Date: Nov. 17, 2005

(54) Method of managing files in a portable digital device

(75) Inventors: Dong-hwan Kim, Seongnam-si (KR); Yun-mi Lee, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/972,882

(22) Filed: Oct. 25, 2004

(30) Foreign Application Priority Data
May 11, 2004 (KR) 2004-33085

(51) Int. Cl. G06F 17/30

(52) U.S. Cl. 707/4

(57) ABSTRACT

Provided is a method for managing files in a portable digital apparatus having a recording medium, and an apparatus adapted to manage files according to the provided method. The method includes storing bit information that indicates that a file exists whenever the file is stored on the recording medium; storing bit information that indicates that a file does not exist whenever the file is deleted from the recording medium; and, when an object file is searched for on the recording medium, searching for the object file on files corresponding to bit information that indicates the existence of the files.

### BACKGROUND OF THE INVENTION

This application claims the priority of Korean Patent Application No. 2004-33085, filed on May 11, 2004, in the Korean Intellectual Property Office, the disclosure of which is incorporated herein in its entirety by reference.

### 1. FIELD OF THE INVENTION

The present invention relates to a method of managing files in a portable digital apparatus having a recording medium according to user's manipulation, and an apparatus adapted to perform the method.

### 2. DESCRIPTION OF THE RELATED ART

A conventional portable digital apparatus, for example, a digital imaging apparatus disclosed in U.S. Pat. No. 5,477,264, entitled “Electronic Imaging System Using a Removable Software-enhanced Storage Device” stores files on a recording medium, deletes the files from the recording medium, and searches for an object file having a certain name on the recording medium according to user input.

In such a conventional portable digital apparatus, whenever a file is stored in a directory, all the files are rearranged so that names of the files in the directory are disposed in sequence. In addition, all of the files stored on the recording medium are rearranged during booting of the portable digital apparatus, because a search speed is increased when an object file having a certain name inputted by a user is searched for on the recording medium. However, due to such rearrangement, the booting speed and the entire operational speed of the portable digital apparatus is reduced.

### SUMMARY OF THE INVENTION

The present invention provides a method of managing files in a portable digital apparatus by which a search speed is increased without rearranging files stored on a recording medium, and provides an apparatus adapted to perform the method.

According to an aspect of the present invention, there is provided a method of managing files in a portable digital apparatus having a recording medium, the method comprising storing bit information that indicates that a file exists whenever the file is stored on the recording medium; storing bit information that indicates that a file does not exist whenever the file is deleted from the recording medium; and when an object file having a name inputted by a user is searched for on the recording medium, searching for the object file on files corresponding to bit information that indicates the existence of the files.

According to the method of managing files in the portable digital apparatus, the object file is searched for only on files corresponding to bit information that indicates the existence of the files such that a search speed is increased without rearranging the files.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a perspective view of front and upper portions of a digital camera as a portable digital apparatus according to the present invention;

FIG. 2 is a rear-side view of a rear portion of the digital camera of FIG. 1;

FIG. 3 is a block diagram of the structure of the digital camera of FIG. 1;

FIG. 4A shows a case where files are sequentially stored on a recording medium using a digital camera processor (DCP) of FIG. 3;

FIG. 4B shows a case where several files are deleted from the files of FIG. 4A;

FIG. 4C shows a case where files are stored in several areas from areas of the deleted files of FIG. 4B;

FIG. 5 is a flowchart illustrating a basic file management algorithm of the DCP of FIG. 3;

FIG. 6 is a flowchart illustrating a search algorithm of FIG. 5;

FIG. 7A shows a case where bit information is stored in each of a plurality of existence-information memories according to types of the files of FIG. 4A;

FIG. 7B shows a case where bit information is stored in each of a plurality of existence-information memories according to types of the files of FIG. 4B; and

FIG. 7C shows a case where bit information is stored in each of a plurality of existence-information memories according to types of the files of FIG. 4C.

### DETAILED DESCRIPTION OF THE INVENTION

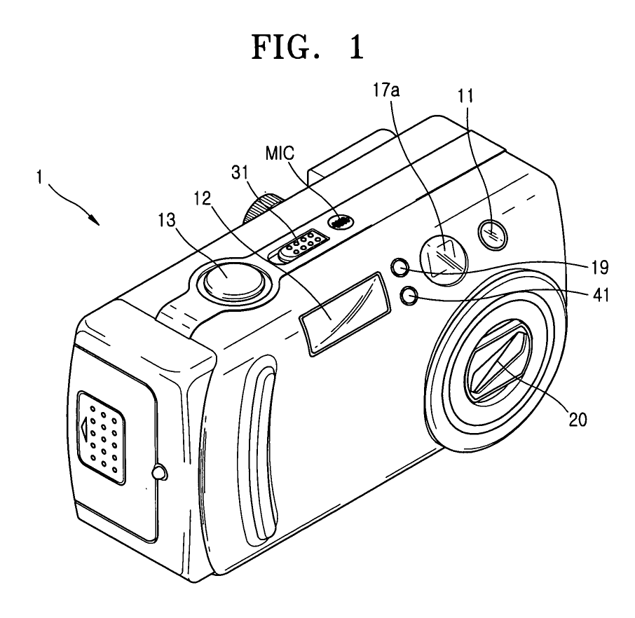

Referring to FIG. 1, a front portion of a digital camera 1 as a digital imaging apparatus includes a microphone (MIC), a self-timer lamp 11, a flash 12, a shutter release button 13, a view finder 17a, a flash-light quantity sensor 19, a power switch 31, a lens unit 20, and a remote receiving unit 41.

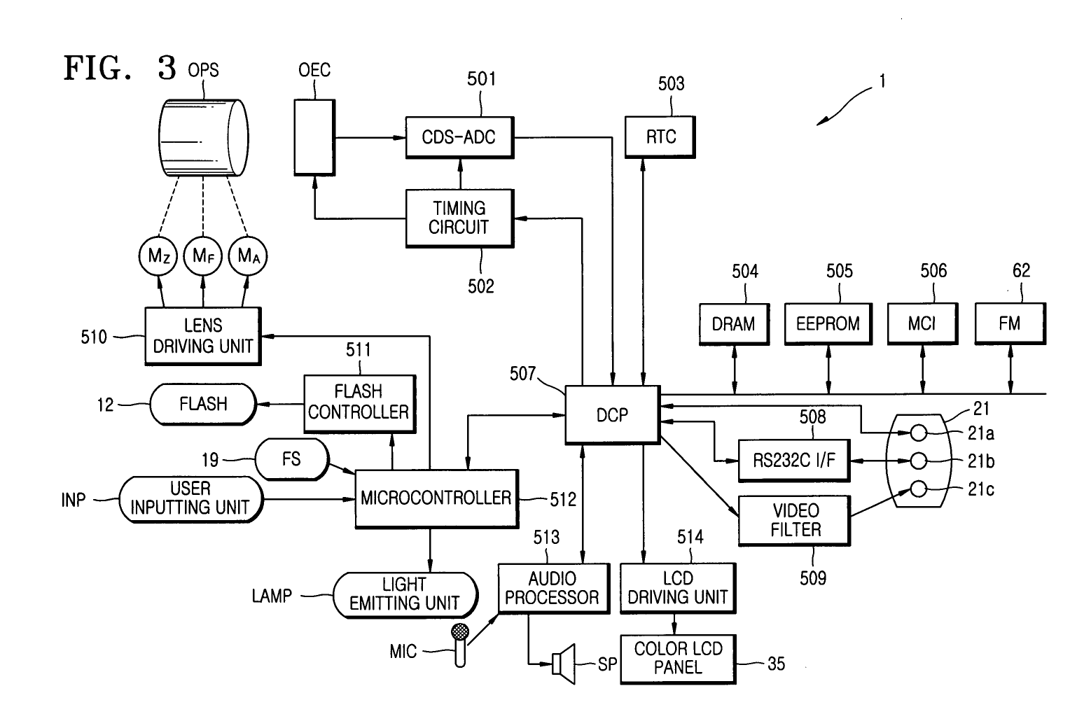

The self-timer lamp 11 operates during a setting period from a time when the shutter release button 13 is pressed to a time when an image starts to be captured in a self-timer mode. The flash-light quantity sensor 19 senses the quantity of light when the flash 12 operates and inputs the quantity of light sensed into a digital camera processor (DCP) (507 of FIG. 3) through a microcontroller (512 of FIG. 3).

The remote receiving unit 41 receives an instruction signal for imaging infrared rays from a remote controller (not shown) and inputs the received instruction signal into the digital camera processor (DCP) 507 through the microcontroller 512.

The shutter release button 13 has a two-stage structure. That is, when the user operates a wide angle-zoom button 39W and a telephoto-zoom button 39T and then presses the shutter release button 13 only at a first stage, a signal S1 generated from the shutter release button 13 is turned on, and when the user presses the shutter release button 13 to a second stage, a signal S2 generated from the shutter release button 13 is turned on.

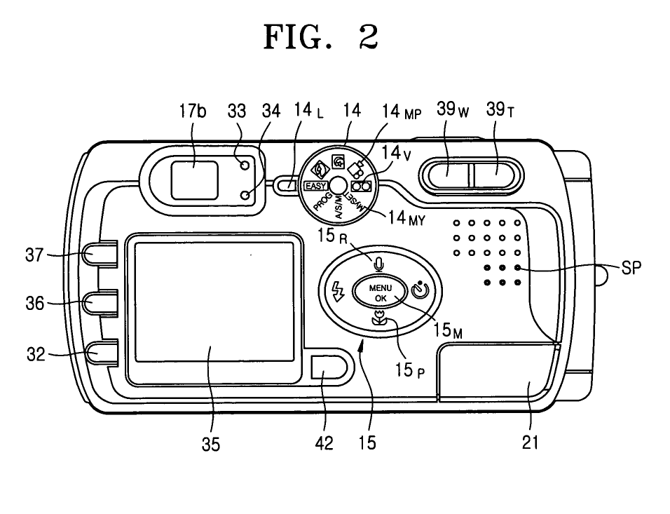

Referring to FIG. 2, a rear portion of the digital camera 1 includes a mode dial 14, functional buttons 15, a manual-focusing/deletion button 36, a manual-adjustment/play button 37, a play mode button 42, a speaker SP, a monitor button 32, an automatic-focusing lamp 33, a view finder 17b, a flash stand-by lamp 34, a color LCD panel 35, a wide angle-zoom button 39W, a telephoto-zoom button 39T, an external interface unit 21, and a speech recognition button (not shown).

The mode dial 14 is used to select an operational mode for the camera, such as a simple imaging mode, a program imaging mode, a character imaging mode, a night view imaging mode, a manual imaging mode, a moving image imaging mode 14MP, a user setting mode 14MY, and a recording mode 14V. The user setting mode 14MY is an operational mode in which imaging information needed in an imaging mode is set by the user. The recording mode 14V is an operational mode in which the camera simply records sound such as a user's speech.

The functional buttons 15 are used to perform specific functions of the digital camera 1 and are used as direction-movement buttons for an activation cursor on a menu screen of the color LCD panel 35.

For example, the user presses a macro/downward-movement button 15P in the imaging mode so that near field automatic focusing is set. In addition, when the user presses the macro/downward-movement button 15P while a menu for setting conditions of an operational mode is displayed by pressing a menu/selection-confirmation button 15M, the activation cursor moves downwards.

When the user presses a speech-memo/upward-movement button 15R, recording can be performed for 10 seconds after a subsequent imaging operation. In addition, when the user presses the speech-memo/upward-movement button 15R while the menu for setting conditions of an operational mode is displayed, the activation cursor moves upwards. The menu may be displayed by pressing the menu/selection-confirmation button 15M. In addition, when the user presses the menu/selection-confirmation button 15M while the activation cursor is placed in a certain selection menu, an operation corresponding to the selection menu is performed.

The manual-focusing/deletion button 36 is used to manually perform a focusing or deletion operation in the imaging mode. The manual-adjustment/play button 37 is used to perform manual adjustment of specific conditions and to perform a stop or play operation in a play mode. The play mode button 42 is used to convert a current mode into a play or preview mode.

The monitor button 32 is used to control an operation of the color LCD panel 35. For example, in the imaging mode, when the user presses the monitor button 32 once, an image of a subject and imaging information about the image are displayed on the color LCD panel 35, and when the user presses the monitor button 32 twice, power applied to the color LCD panel 35 is cut off. In addition, in the play mode, when the user presses the monitor button 32 once while a certain image file is played, imaging information about the played image file is displayed on the color LCD panel 35, and when the user presses the monitor button 32 twice, only a pure image is displayed on the color LCD panel 35.

The automatic-focusing lamp 33 operates when focus adjustment is correctly performed. The flash stand-by lamp 34 operates when the flash (12 of FIG. 1) is in an operation stand-by state. A mode instruction lamp 14L is a selection mode of the mode dial 14.

FIG. 3 shows the structure of the digital camera 1 of FIG. 1. The structure and operation of the digital camera 1 according to the present invention will now be described with reference to FIGS. 1 through 3.

An optical system OPS having the lens unit and the filter unit optically processes light emitted from a subject.

The lens unit of the optical system OPS includes a zoom lens, a focus lens, and a compensation lens.

When the user presses the wide angle-zoom button 39W or the telephoto-zoom button 39T of a user inputting unit INP, a signal corresponding to the wide angle-zoom button 39W or the telephoto-zoom button 39T is input into the microcontroller 512. As such, the microcontroller 512 controls a lens driving unit 510 so that a zoom motor MZ is driven and the zoom lens moves. That is, when the wide angle-zoom button 39W is pressed, the focal length of the zoom lens becomes short and the angle of view becomes wide. In addition, when the telephoto-zoom button 39T is pressed, the focal length of the zoom lens becomes long and the angle of view becomes narrow. In this case, since the position of the focus lens is adjusted while the position of the zoom lens is set, the angle of view is barely affected by the position of the focus lens.

Meanwhile, in an automatic focusing mode, a main controller embedded in a digital camera processor (DCP) 507 controls the lens driving unit 510 by the microcontroller 512 so that a focusing motor MF is driven. As such, the focus lens moves, and the position of the focus lens is set in which the number of high frequency components of an image signal is maximal while the focus lens moves, such a position being represented by the number of driving steps of the focus motor MF. In this case, in order to reduce an imaging time, one is selected from partial position areas of a unit frame, for example, central, left, and right position areas of the unit frame, and the position of the focus lens is set in which the number of high frequency components of the image signal is maximal in the selected position area, for example, the number of driving steps of the focus motor MF.

The compensation lens of the lens unit of the optical system OPS compensates the entire refractive index and is not driven separately. MA is a motor which drives an aperture (not shown).

In the filter unit of the optical system OPS, an optical low pass filter (OLPF) removes optical noise of a high frequency component. An infra-red cut filter intercepts infrared components of incident light.

An optoelectronic converter (OEC) for a charge coupled device (CCD) or a complementary metal-oxide-semiconductor (CMOS) converts light emitted from the optical system OPS into an electrical analog signal. In this case, the DCP 507 controls a timing circuit 502 to control operations of the OEC and a correlation double sampler and analog-to-digital converter (CDS-ADC) 501 as an analog-to-digital converter (ADC). The CDS-ADC 501 processes an analog signal generated from the OEC, removes high-frequency noise of the analog signal, adjusts amplitude thereof, and converts the analog signal into a digital signal.

A real-time clock (RTC) 503 provides time information to the DCP 507. The DCP 507 processes a digital signal generated from the CDS-ADC 501 and generates a digital image signal classified into luminance and chromaticity signals.

A light-emitting unit LAMP, driven by the microcontroller 512 in response to control signals generated from the DCP 507 having a main controller, includes the self-timer lamp 11, the automatic-focusing lamp 33, the mode instruction lamp 14L, and the flash stand-by lamp 34. The INP includes the shutter release button 13, the mode dial 14, the functional buttons 15, the monitor button 32, the manual-focusing/deletion button 36, the manual-adjustment/play button 37, the wide angle-zoom button 39W, and the telephoto-zoom button 39T.

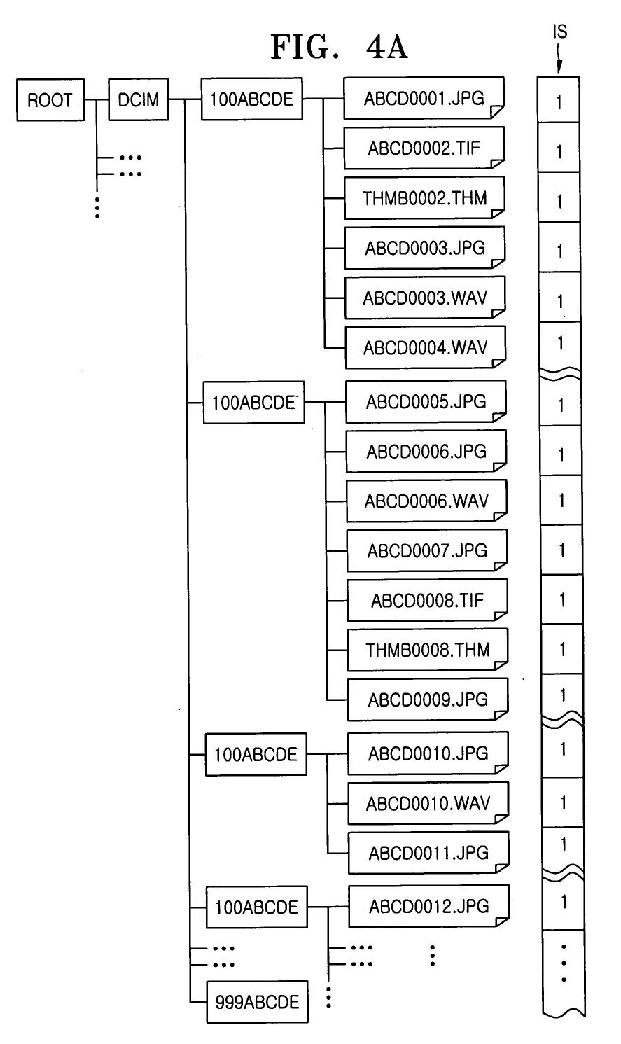

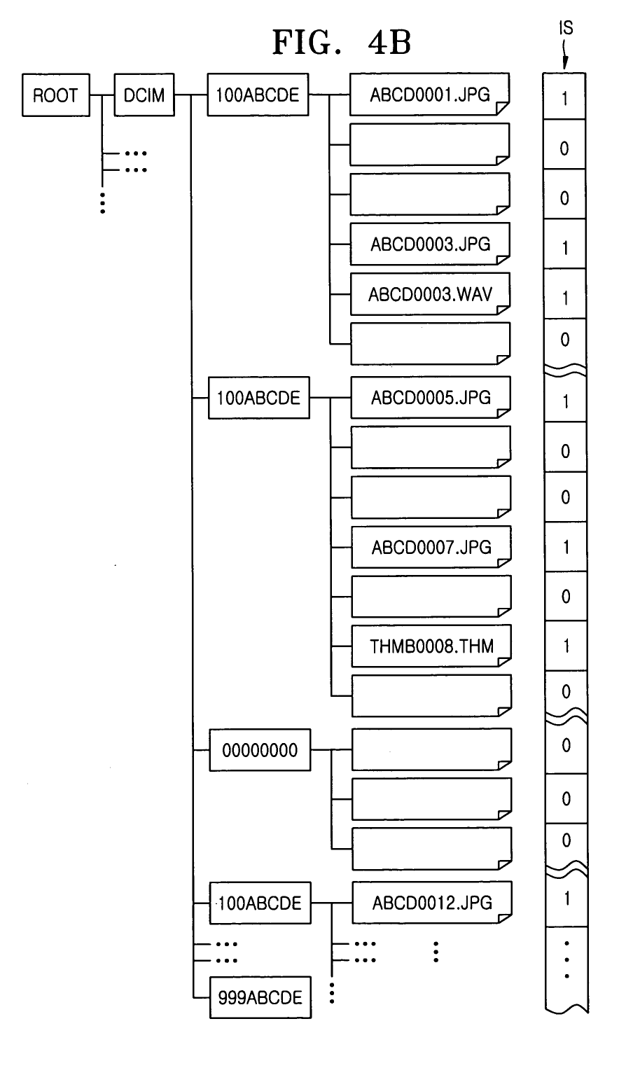

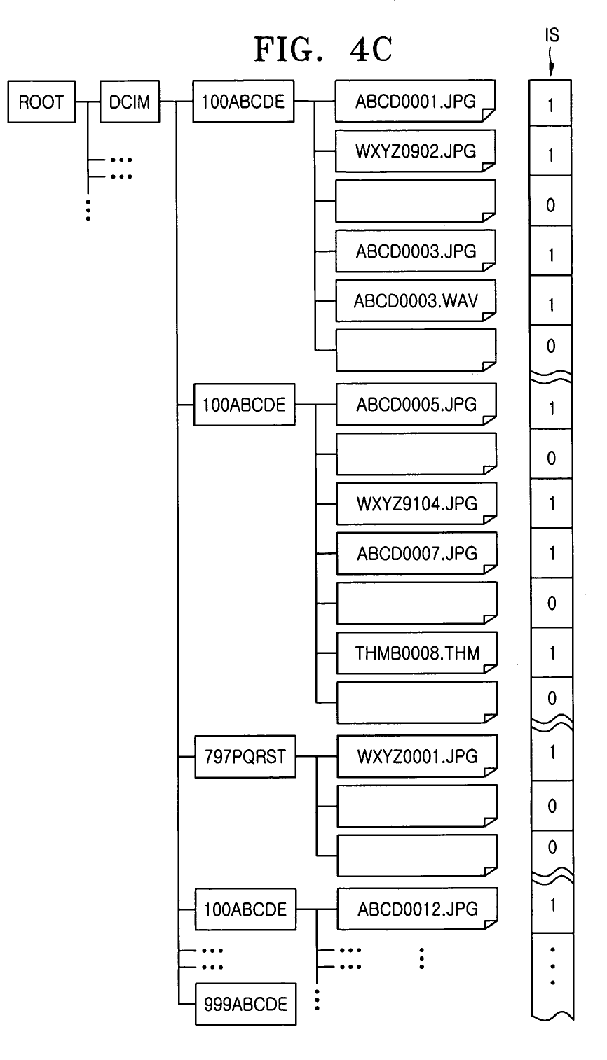

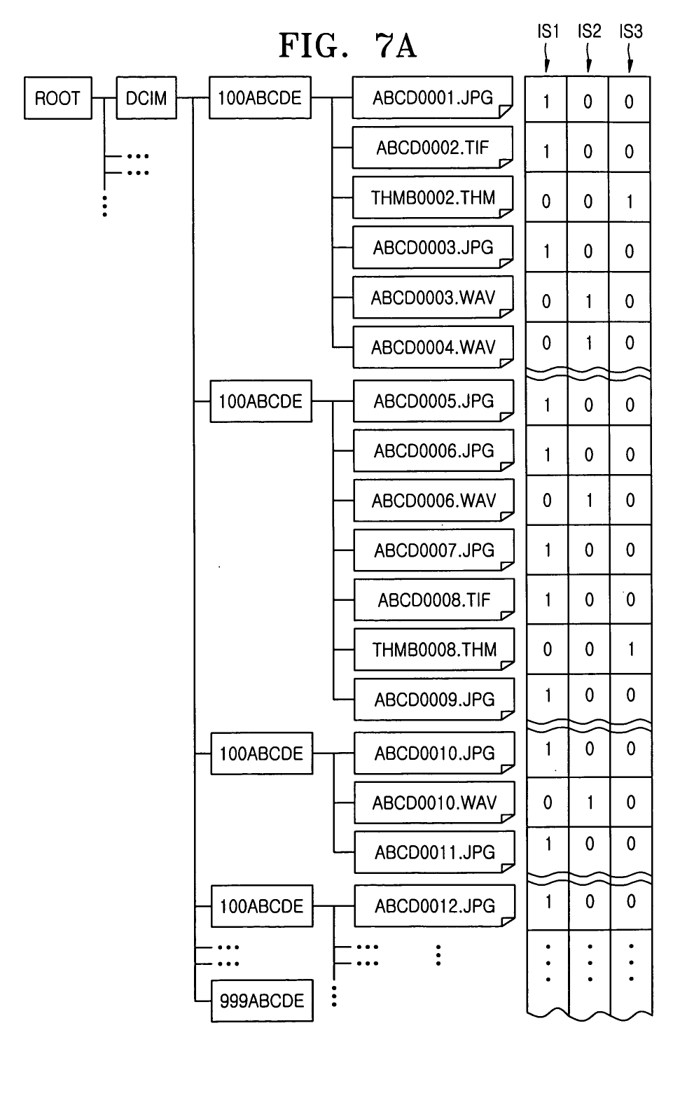

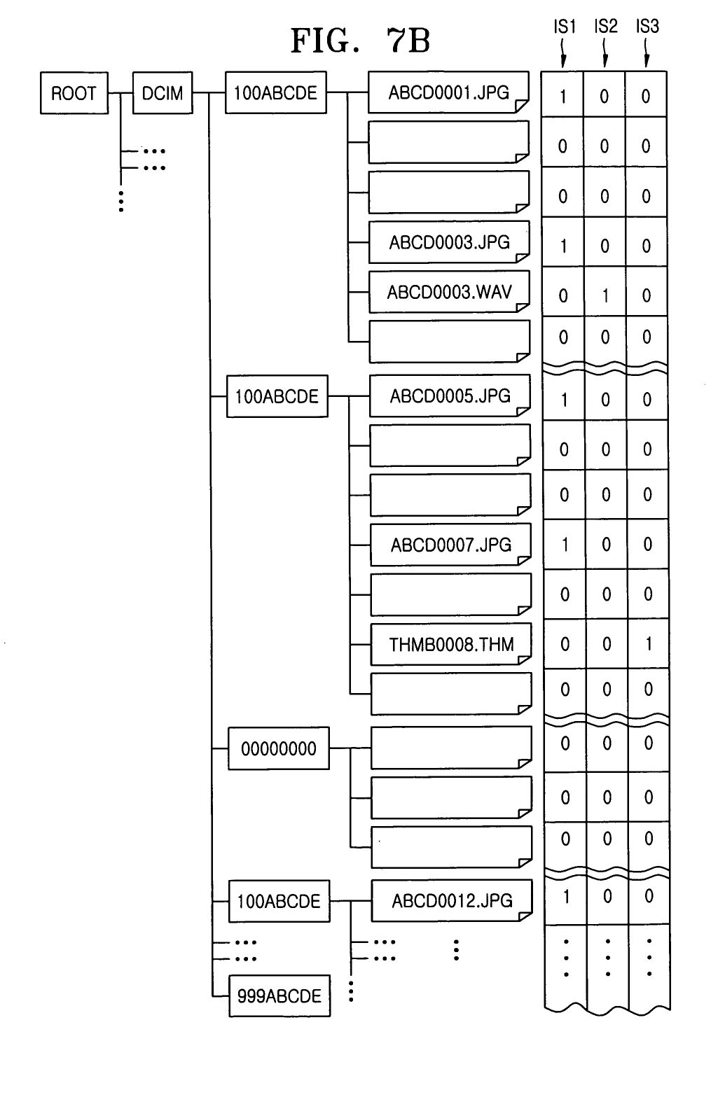

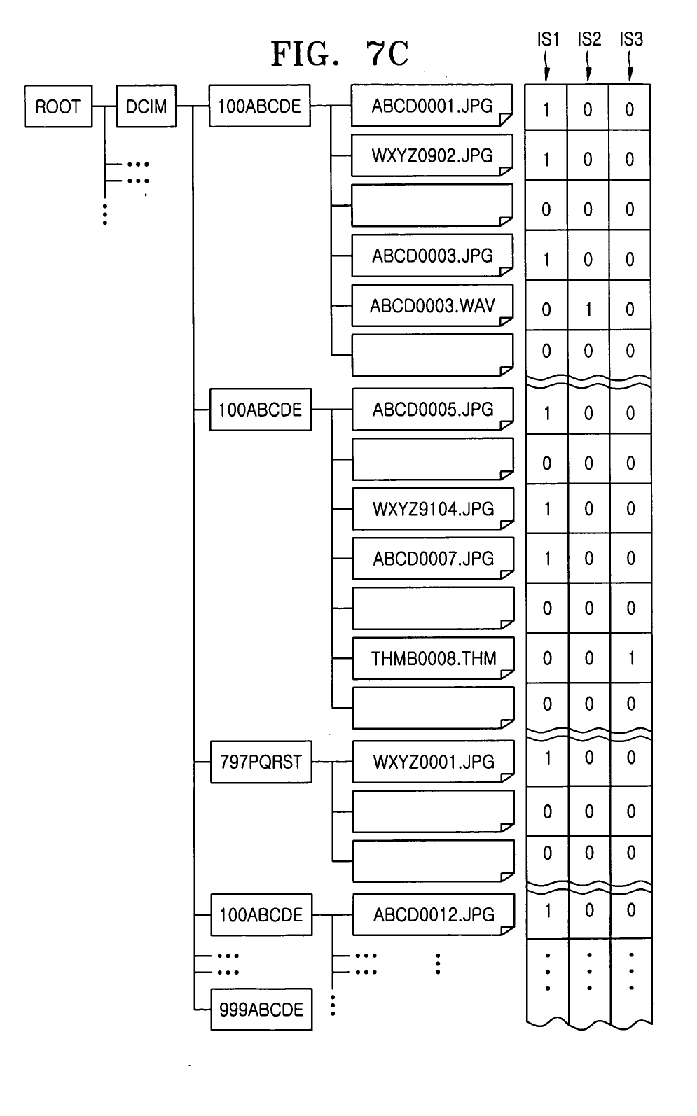

The digital image signal generated from the DCP 507 is temporarily stored in a dynamic random access memory (DRAM) 504. Meanwhile, the DRAM 504 includes at least one existence-information memory. That is, since files stored in a memory card as a recording medium are not rearranged, so as to increase the booting speed and operational speed of the digital camera 1, bit information, indicating whether a file exists in each file allocation area of the recording medium, is stored in at least one existence-information memory in the DRAM 504 so as to increase a search speed. When only one existence-information memory is used, the bit information about each file allocation area is stored in the same existence-information memory regardless of types of stored or deleted files (see FIGS. 4A through 4C). When a plurality of existence-information memories are used to increase a search speed, the bit information is stored in each of the plurality of existence-information memories according to types of stored or deleted files (see FIGS. 7A through 7C). Associated contents will be described in greater detail with reference to FIGS. 4A through 7C.

An algorithm needed in the operation of the DCP 507 is stored in an electrically erasable and programmable read only memory (EEPROM) 505. A memory card as a recording medium is attached or detached by a user to or from a memory card interface (MCI) 506. Setting data needed in the operation of the DCP 507 is stored in a flash memory FM.

The digital image signal generated from the DCP 507 is input into an LCD driving unit 514. As a result, an image is displayed on the color LCD panel 35.

Meanwhile, the digital image signal generated from the DCP 507 may be transmitted by serial communication via a universal serial bus (USB) connection unit 21a or a connection unit 21b to be connected to a RS232C interface 508. Alternatively, the digital image signal may be transmitted as a video signal from a video filter 509 and a video outputting unit 21c. In this case, a controller is embedded in the DCP 507.

An audio processor 513 outputs a speech signal generated from the MIC to the DCP 507 or the speaker SP and an audio signal generated from the DCP 507 to the speaker SP.

Meanwhile, the microcontroller 512 controls the operation of a flash controller 511 in response to a signal generated from the flash-light quantity sensor 19 to drive the flash 12.

FIG. 4A shows a case where files are sequentially stored in a memory card as a recording medium using the DCP 507 of FIG. 3. Referring to FIG. 4A, a directory “DCIM” in which files are stored is generated under an uppermost directory “ROOT”, and sub-directories “100ABCDE” through “999ABCDE” generated whenever a directory generation signal is inputted by a user exist under the directory “DCIM”. Here, the directory “DCIM” and the sub-directories “100ABCDE” through “999ABCDE” represent names of directories using a design rule for a camera file system (DCF) applied to digital cameras.

A first half portion of the files stored in each of the sub-directories “100ABCDE” through “999ABCDE” represents a unique code, and a second half portion thereof represents a file index. As shown in FIG. 4A, the files are sequentially stored in each of the directories “100ABCDE” through “999ABCDE” because the user has stored them by simply imaging or recording without deleting or copying them from an external device.

Meanwhile, the DRAM (504 of FIG. 3) includes one existence-information memory IS. In the existence-information memory IS, bit information that indicates that a file exists is 1′, and bit information that indicates that a file does not exist is ‘0’. The existence-information memory IS has an effect when the files are deleted or copied from the external device and an object file having a certain name is searched for.

FIG. 4B shows a case where several files are deleted from the files of FIG. 4A. In this case, bit information of the existence-information memory IS corresponding to areas of the deleted files is updated as ‘0’. In addition, when all of the files of a directory are deleted, the DCP 507 revises the name of the directory as ‘00000000”, so as to increase a search speed. That is, the directory having a name “00000000” is excluded from an object to be searched for.

FIG. 4C shows a case where files are stored in several areas from the areas of the deleted files of FIG. 4B. In FIG. 4C, the files are not sequentially stored because files are copied from an external device by the user. Here, bit information corresponding to a newly stored file is updated as ‘1’. When a file is stored by imaging or recording using the digital camera 1, the stored file is placed in the last position of files of a corresponding directory. In this case, bit information corresponding to the file is also updated as ‘1’.

As shown in FIGS. 4B and 4C, when the object file having a certain name inputted by the user is searched for on a memory card in a state where all of the files are not rearranged, the object file is searched for only on files in which bit information of the existence-information memory IS is ‘1’. That is, since the object file is searched for only on names of the files corresponding to bit information ‘1’, the search speed can be increased without rearranging the files. Since a plurality of bit information is simultaneously inspected in the existence-information memory IS, a time for inspecting the bit information self is short and needs not to be considered.

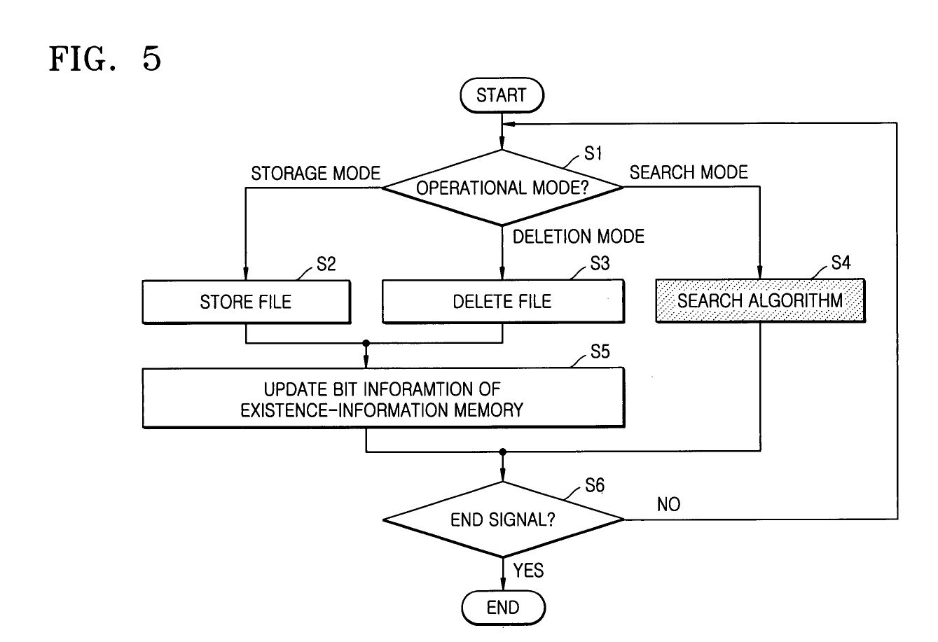

A basic file management algorithm of the DCP 507 of FIG. 3 will now be described with reference to FIGS. 4B through 5.

When an operational mode is a storage mode (operation S1), a file is stored in a memory card as a recording medium (operation S2). In addition, bit information corresponding to the stored file is stored as ‘1’ in the existence-information memory IS in the DRAM (504 of FIG. 3) (operation S5).

When the operational mode is a deletion mode (operation S1), the file is deleted from the memory card as the recording medium (operation S3). In addition, bit information corresponding to the stored file is stored as ‘O’ in the existence-information memory IS in the DRAM (504 of FIG. 3) (operation S5).

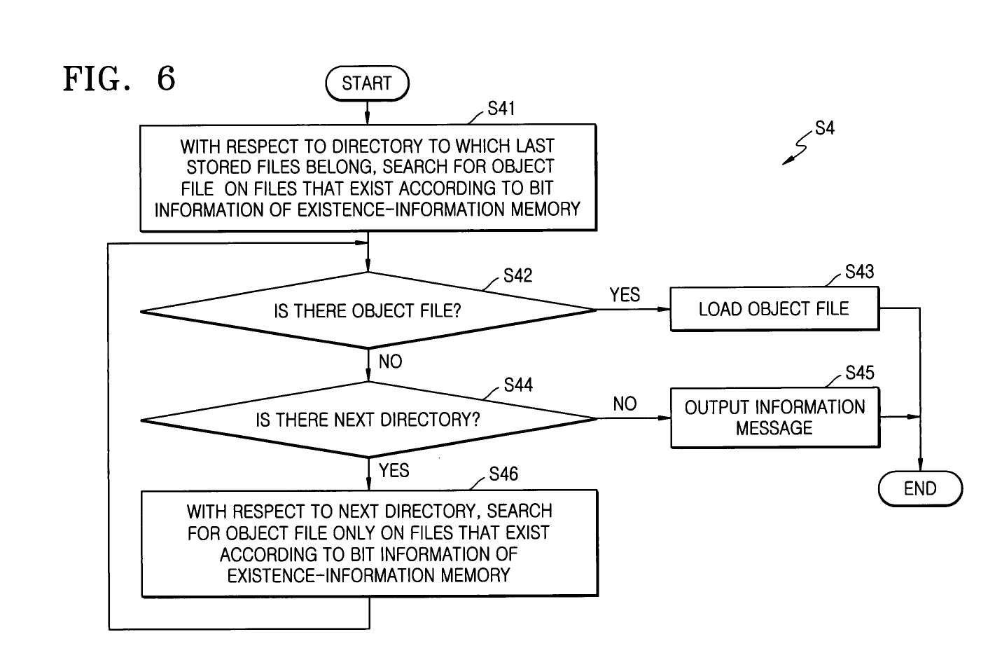

When the operational mode is a search mode (operation S1), a search algorithm shown in FIG. 6 is executed (operation S4).

All of the operations are repeatedly performed until an end signal is inputted by the user (operation S6).

A search algorithm S4 of FIG. 5 will now be described in detail with reference to FIG. 6.

First, an object file is searched for only on files that exist according to bit information of the existence-information memory IS in the DRAM (504 of FIG. 3) (operation S41). That is, since the object file is searched for only on names of the files that exist according to bit information ‘1’, a search speed can be increased without rearranging the files.

When there is the object file in operation 41, the object file is read from the memory card and loaded, and an execution algorithm is terminated (operations S42 and S43).

When there is no object file in operation 41 (operation S42), the following operations are performed.

When there is a next directory to be searched for, with respect to the next directory, an object file is searched for only on files that exist according to bit information of the existence-information memory IS (operations S44 and S46). That is, since the object file is searched for only on names of the files that exist according to bit information ‘1’, the search speed can be increased without rearranging the files. Next, operation S42 and associated operations are repeatedly performed.

When there is no next directory to be searched for, an information message related to an error is output, and an execution algorithm is ended (operation S45).

FIG. 7A shows a case where bit information is stored in each of three existence-information memories IS1 through IS3 according to types of the files of FIG. 4A. FIG. 7B shows a case where bit information is stored in each of three existence-information memories IS1 through IS3 according to types of the files of FIG. 4B. FIG. 7C shows a case where bit information is stored in each of first through third existence-information memories IS1 through IS3 according to types of the files of FIG. 4C. Thus, only a difference between the method of managing files shown in FIGS. 7A through 7C and the method of managing files shown in FIGS. 4A through 4C will now be described.

Existence information of files corresponding to a video file is stored in the first existence-information memory IS1 in the DRAM (504 of FIG. 3). Existence information of files corresponding to an audio file is stored in the second existence-information memory IS2 in the DRAM (504 of FIG. 3). Existence information of files corresponding to a reduced video file is stored in the third existence-information memory IS3 in the DRAM (504 of FIG. 3).

As a result, when a file corresponding to the video file is searched for, an object file is searched for only on files that exist according to bit information of the first existence-information memory IS1. When a file corresponding to the audio file is searched for, an object file is searched for only on files that exist according to bit information of the second existence-information memory IS2. Similarly, when a file corresponding to the reduced video file is searched for, an object file is searched for only on files that exist according to bit information of the third existence-information memory IS3.

As such, the file search speed can be improved.

As described above, in the method of managing files in the portable digital apparatus according to the present invention, since an object file is searched for only on files corresponding to bit information that indicates the existence of files, a search speed can be increased without rearranging the files.

While the present invention has been particularly shown and described with reference to exemplary embodiments thereof, it will be understood by those skilled in the art that various changes in form and details may be made therein without departing from the spirit and scope of the invention as defined by the following claims.

1. A method of managing files in a portable digital device having a recording medium, the method comprising:
storing information that indicates that a file exists whenever the file is stored on the recording medium;
storing information that indicates that a file does not exist whenever the file is deleted from the recording medium; and
when an object file is searched for on the recording medium, searching for the object file on files corresponding to information that indicates the existence of the files.

2. The method of claim 1, further comprising:
storing information indicating that all files of a directory have been deleted whenever all the files of a directory have been deleted; and
during a search for an object file on the recording medium, excluding directories for which the stored information indicates that all files of the directory have been deleted.

3. The method of claim 2, wherein the step of storing information indicating that all files of a directory have been deleted comprises:
changing the name of the directory to indicate that all files of the directory have been deleted.

4. The method of claim 1, wherein the step of storing information that indicates that a file exists comprises storing information that indicates that a file exists and is of a particular type of file.

5. The method of claim 3, further comprising:
when an object file of a particular type is searched for on the recording medium, only searching for the object file of the particular type on files corresponding to information that indicates the existence of the particular type of file.

6. The method of claim 1, wherein the step of searching for the object file further comprises:
initially searching for the object file on a directory including the most recently stored file.

7. The method of claim 1, wherein the step of searching for the object file further comprises:
searching for the object file one directory at a time; and
if the object file is not found on a directory being searched, continuing to search on another directory.

8. The method of claim 1, wherein files are not rearranged upon booting.

9. The method of claim 1, wherein files are not rearranged when a file is stored.

10. The method of claim 1, wherein the information that indicates that a file exists is stored in random access memory and the information that indicates that a file does not exist is stored in random access memory.

11. The method of claim 9, wherein the random access memory is dynamic random access memory.

12. The method of claim 1, wherein the information that indicates that a file exists or does not exist is bit information.

13. The method of claim 1, wherein the recording medium is a memory card.

14. The method of claim 1, wherein the portable digital device is a digital camera.

15. A portable digital device, comprising:
a microprocessor;
a random access memory; and
a recording medium,
wherein the random access memory stores information that indicates that a file exists whenever the file is stored on the recording medium and stores information that indicates that a file does not exist whenever the file is deleted from the recording medium, and
wherein when the device searches for an object file on the recording medium, the device searches for the object file on files corresponding to information that indicates the existence of the files.

16. The device of claim 15, wherein the random access memory includes an existence-information memory that contains the information that indicates that a file exists or not.

17. The device of claim 15, wherein the random access memory is dynamic random access memory.

18. The device of claim 15, further comprising:
an EEPROM that stores at least one algorithm that assists in the functioning of the microprocessor.

19. The device of claim 15, wherein the microprocessor is a digital signal processor.

20. The device of claim 15, wherein the recording medium is a memory card.

21. The device of claim 15, wherein the stored information indicating that a file exists is bit information and the stored information indicating that a file does not exist is bit information.

22. The device of claim 15, wherein the device stores information indicating that all files of a directory have been deleted whenever all the files of a directory have been deleted; and
during a search for an object file on the recording medium, the device excludes directories for which the stored information indicates that all files of the directory have been deleted.

23. The device of claim 15, wherein the device stores information that indicates that a file exists and is of a particular type.

24. The device of claim 23, wherein when the device searches for an object file of a particular type, the device only searches for the object file of the particular type on files corresponding to information that indicates the existence of the particular type of file.

25. The device of claim 15, wherein the device does not rearrange files upon booting.

26. The device of claim 15, wherein the device further comprises:
an optical system;
an optoelectronic converter; and
an analog-to-digital converter.
